(19) United States
(12) Patent Application Publication
(10) Pub. No.: US 2026/0139982 A1
(43) Pub. Date: May 21, 2026

(54) METHOD AND DEVICE FOR DISAGGREGATION OF FLUID CONSUMPTION DATA

(71) Applicant: SAGEMCOM ENERGY & TELECOM SAS, BOIS-COLOMBES (FR)

(72) Inventor: Henri TEBOULLE, BOIS-COLOMBES (FR)

(21) Appl. No.: 19/394,158

(22) Filed: Nov. 19, 2025

(30) Foreign Application Priority Data
Nov. 19, 2024 (FR) 2412656

(51) Int. Cl. G01F 13/00; G06Q 50/06

(52) U.S. Cl. CPC G01F 13/006; G06Q 50/06

(57) ABSTRACT

A method for disaggregating fluid-consumption data, using the individual electricity consumption for each fluid-consuming electrical appliance in the system, over a time period, and the overall fluid consumption of all the fluid-consuming appliances in the system includes determining the fluid consumption of each fluid-consuming electrical appliance, determining a first remaining fluid consumption other than the consumption due to the fluid-consuming electrical appliances, and disaggregating the first remaining fluid consumption, per fluid-consuming non-electrical appliance, by searching for activity phases of the non-electrical appliance considered in the data representative of the first remaining fluid consumption, an activity phase being identified by a volume of fluid consumption during the activity phase and an activity phase duration.

### CROSS-REFERENCE TO RELATED APPLICATIONS

The present application claims priority to French Application No. 2412656 filed with the Intellectual Property Office of France on Nov. 19, 2024, which is incorporated herein by reference in its entirety for all purposes.

### TECHNICAL FIELD

The various exemplary embodiments described in the present disclosure relate to a method and a device for disaggregating fluid-consumption data. The device can especially be, but is not limited to, a local electricity meter, a remote server, or any appliance equipped with a processor and running suitable software code.

### BACKGROUND

We often consume a resource without being fully aware of the magnitude of this consumption. Thus, repeated flushing during the day can lead to excessive water consumption. Users are not necessarily aware of how often they flush, or of how much water they use. Knowing the fluid consumption, especially of water, of individual pieces of equipment in a household can help raise user awareness of how to use the resource, and thus enable more rational use. It is therefore useful to offer a subscriber of a consumption network for a fluid resource (water, gas, etc.) data on resource use per appliance, referred to as “disaggregated data”.

It has been proposed to provide the various pieces of equipment of a household with individual metering appliances. However, this is an expensive approach. It is therefore preferable to disaggregate overall household consumption.

There are techniques for disaggregating electricity consumption data that make it possible to determine which pieces of electrical equipment have consumed electricity, for example in a residential premises. However, these techniques are difficult to transpose to consumption data for a fluid, such as gas and water, in order to determine which pieces of equipment consume fluids, or to determine the time-dependent consumption of each piece of equipment. Indeed, the same reasoning cannot be applied to electricity as to gas and water. The electricity consumption of various pieces of equipment is added together, and a total load curve for the premises gives an indication of the pieces of electrical equipment that are consuming. On the other hand, taking water as an example, it is often drawn at a constant flow rate, to the maximum capacity of the water inlet. This makes it difficult to determine, from time-dependent water consumption, which of several candidate pieces of equipment is actually consuming water at any given time.

It has been suggested to use electricity consumption data to refine a disaggregation of data relating to water. However, the techniques employed require relatively large computing resources, which are incompatible with the computing resources available in some pieces of household equipment, such as electricity meters.

An efficient solution is therefore required, with low requirements in terms of computing power, and which can be implemented by appliances that have limited computing resources.

### SUMMARY OF THE INVENTION

A first aspect relates to a method implemented by a device comprising a processor for determining fluid consumption by a non-electrical appliance in a system comprising at least one fluid-consuming electrical appliance, and at least one fluid-consuming non-electrical appliance, the method comprising:
obtaining:
a) data representative of the time-dependent evolution of the individual electricity consumption for each fluid-consuming electrical appliance in the system, over a time period;
b) data representative of the time-dependent evolution of the overall fluid consumption of all the fluid-consuming appliances in the system, over the time period;
determining data representative of the time-dependent evolution, over the period, of the fluid consumption of each fluid-consuming electrical appliance by identifying activity phases of this electrical appliance in the data representative of the time-dependent evolution of the individual electricity consumption of this electrical appliance;
determining data representative of the time-dependent evolution, over the period, of a first remaining fluid consumption other than the consumption due to the fluid-consuming electrical appliances;
disaggregating the data representative of the time-dependent evolution, over the period, of the first remaining fluid consumption, per fluid-consuming non-electrical appliance, by searching for activity phases of the non-electrical appliance considered in the data representative of the first remaining fluid consumption,
an activity phase being identified by a volume of fluid consumption during the activity phase and a duration of the activity phase.

The fluid-using non-electrical devices are characterized by having associated consumption volume and time ranges, and it is merely this simple data that is used when disaggregating the fluid load curve, from which consumption due to the pieces of electrical equipment that are also consuming fluid has been previously removed.

Dedicated fluid meters are not required for each piece of equipment, nor is it necessary to use artificial intelligence or deep learning models that are demanding in terms of processing capacity.

The disclosure applies particularly to a household.

According to one embodiment, aggregating fluid load curves corresponding to the different activity phases identified in the data representative of the time-dependent evolution of the individual electricity consumption (Ce_i) of the electrical appliance, the device having, for each activity phase of this electrical appliance, a fluid load curve covering this activity phase.

According to one embodiment, determining data representative of the time-dependent evolution, over the period, of a second remaining fluid consumption, by subtracting, from the data representative of the evolution over time of the first remaining fluid consumption, data representative of the evolution over time of the consumptions corresponding to the activity phases found for the fluid-consuming non-electrical appliances.

According to one embodiment, a fluid-consuming non-electrical appliance comprises a plurality of operating modes, each operating mode being associated with an activity phase identified by a specific consumption volume and consumption phase duration.

According to one embodiment, searching for an activity phase comprising identifying a constant consumption corresponding to the consumption volume of this activity phase, over the duration of the activity phase.

According to one embodiment, the method comprises a preliminary learning phase for obtaining data representative of the time-dependent evolution of the fluid consumption per fluid-consuming electrical appliance, for an activity phase of the fluid-consuming electrical appliance under consideration, the learning phase comprising, for each fluid-consuming electrical appliance:
identifying N activity phases during which only the device under consideration was active, with N>1;
for each activity phase identified, extracting a time-matched part of data representative of the evolution over time of historical overall fluid consumption;
selecting, from the extracted parts, the part with the lowest cumulative fluid consumption as data representative of the time-dependent evolution of the fluid consumption per fluid-consuming electrical appliance.

According to one embodiment, the method comprises a preliminary learning phase for determining a volume and duration for an activity phase of a fluid-consuming non-electrical appliance, the learning phase comprising:
obtaining empirical data defining, for one or more types of fluid-consuming non-electrical appliance, a respective activity phase duration and a respective volume of fluid consumed during the activity phase;
obtaining data representative of the evolution over time of the overall fluid consumption over a historical period;
obtaining data representative of the evolution over time of the individual electricity consumption of each fluid-consuming electrical appliance for the historical period;
identifying, in the parts of the overall fluid-consumption data during which no fluid-consuming electrical device was active, the time intervals corresponding to the criteria of volume and activity duration of activity phases of fluid-consuming non-electrical appliances of each type of appliance;
adjusting at least the values of consumption volume and activity phase duration on the basis of the values of consumption and activity phase duration of the identified intervals.

According to one embodiment, obtaining data representative of the time-dependent evolution of the individual electricity consumption for each fluid-consuming electrical appliance of the system, over a time period, comprises:
detecting one or more activity phase durations of the fluid-consuming electrical appliance;
for each detected activity phase duration, identifying the one or more parts of the data representative of the time-dependent evolution of the overall fluid consumption corresponding to the detected activity phases, considering only the parts of the overall fluid-consumption data during which no other fluid-consuming electrical device is active;
for each activity phase duration, determining which of the X most recently identified parts has the lowest cumulative consumption over the duration, the determined part being taken as data representative of the time-dependent evolution of the individual electricity consumption for the activity phase under consideration of the appliance, with X>1.

According to one embodiment, the method comprises the system is a household.

According to one embodiment, the method comprises at least one of the following steps:
transmitting data representative of the time-dependent evolution, over the period, of the first remaining fluid consumption, per fluid-consuming non-electrical appliance;
displaying data representative of the time-dependent evolution, over the period, of the first remaining fluid consumption, per fluid-consuming non-electrical appliance.

Another aspect relates to a device provided with a processor and a memory including software instructions, the device being caused to perform one of the described methods when the processor executes the instructions.

In one or more embodiments, the device is one of the following: an electricity meter, a server.

### BRIEF DESCRIPTION OF THE FIGURES

The embodiments will be better understood in light of the following detailed description and the accompanying drawings, which are given by way of illustration only and therefore do not limit the present disclosure.

FIG. 1 is a functional block diagram of a non-limiting example of a device 101 implementing one of the methods described according to one or more embodiments.

FIG. 2 is a schematic block diagram of a first example of a system including a device as shown in the figure.

FIG. 3 is a block diagram of a second example of a system.

FIG. 4 is a block diagram of a third example of a system.

FIG. 5 is a flowchart of a method for disaggregating fluid-consumption data according to one or more exemplary embodiments.

FIG. 6 is a flowchart illustrating a first example of a learning phase.

FIG. 7 is a graph showing an electricity and water load curve for the first program of a washing machine.

FIG. 8 is a graph showing an electricity and water load curve for a second program of a washing machine.

FIG. 9 is a flowchart illustrating a second example of a learning phase.

FIG. 10 is a flowchart of a method for determining the individual fluid load curve for an activity phase of a fluid-consuming electrical appliance.

FIG. 11 is a flowchart of a method for determining data representative of the average fluid consumption and consumption phase duration, per fluid-consuming non-electrical appliance, without prior learning.

### DETAILED DESCRIPTION

Various embodiments will now be described in more detail, by way of non-limiting examples, with reference to the drawings accompanying the present disclosure and illustrating certain exemplary embodiments.

The specific structural and functional details disclosed herein are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

In the following description, identical, similar or analogous elements will be referred to by the same reference numbers. The block diagrams, flowcharts and message sequence diagrams in the figures shows the architecture, functionalities and operation of systems, apparatuses, methods and computer program products according to one or more exemplary embodiments. Each block of a block diagram or each step of a flowchart may represent a module or a portion of software code comprising instructions for implementing one or more functions. According to certain implementations, the order of the blocks or the steps may be changed, or else the corresponding functions may be implemented in parallel. The method blocks or steps may be implemented using circuits, software or a combination of circuits and software, in a centralized or distributed manner, for all or part of the blocks or steps. The described systems, devices, processes and methods may be modified or subjected to additions and/or deletions while remaining within the scope of the present disclosure. For example, the components of a device or system may be integrated or separated. Likewise, the features disclosed may be implemented using more or fewer components or steps, or even with other components or by means of other steps. Any suitable data-processing system can be used for the implementation. An appropriate data-processing system or device comprises for example a combination of software code and circuits, such as a processor, controller or other circuit suitable for executing the software code. When the software code is executed, the processor or controller prompts the system or apparatus to implement all or part of the functionalities of the blocks and/or steps of the processes or methods according to the exemplary embodiments. The software code can be stored in non-volatile memory or on a non-volatile storage medium (USB key, memory card or other medium) that can be read directly or via a suitable interface by the processor or controller.

The embodiments disclosed relate to the disaggregation of fluid-consumption data (water, gas, etc.) for various pieces of fluid-consuming equipment. These pieces of equipment can be electrical or non-electrical equipment. Disaggregation is understood to mean determining the individual fluid consumption of fluid-consuming equipment, electrical or not, from data representative of overall consumption, for example consumption as measured by a metering device determining the overall consumption of a household.

By way of example, in a home environment, the types of electrical equipment consuming water may typically comprise (non-exhaustive list):
A washing machine
A dishwasher
A toilet macerator
A swimming-pool filling pump
An automatic garden sprinkler

In the same context, the types of non-electrical equipment consuming fluid (water in this example) may comprise (non-exhaustive list):
A toilet flush mechanism
A shower
A bathtub

This is fluid-consuming non-electrical equipment that can be associated with a volume of water consumed and a duration of activity during which consumption takes place. Both amounts may be subject to margins of error. For example, in one operating mode, a toilet flush mechanism will consume 6.1±3 liters of water over a period of 45 s±30 s. In the present disclosure, the fluid consumption is assumed to be continuous at a constant value over the entire activity period of a piece of fluid-consuming non-electrical equipment.

There may be non-electrical equipment/appliances with identical functions, but of different types because they are defined by parameters with different values: a different volume of fluid consumption during the activity phase and/or a different duration of the activity phase. For example, there could be two different toilet flush mechanisms because their water volume is different. In this case, they will each have their own type and can be distinguished as different pieces of equipment. On the contrary, if two pieces of equipment/appliances in a household have identical operating parameters (for example, two identical toilet flush mechanisms), they will be considered as a single piece of equipment/appliance.

Additional water consumption may be due, for example, to leaks in the customer's installation, or to kitchen or bathroom faucets (non-exhaustive list).

When the fluid under consideration is gas, the electrical equipment consuming gas may include a gas boiler (non-exhaustive list).

According to one particular embodiment, a piece of equipment that consumes electricity and/or fluids can have different operating modes, corresponding to different operating ranges and consumption levels. Taking these different modes into account significantly improves the disaggregation.

Although water will generally be referred to hereinafter, the examples described apply equally well to any other fluid such as gas.

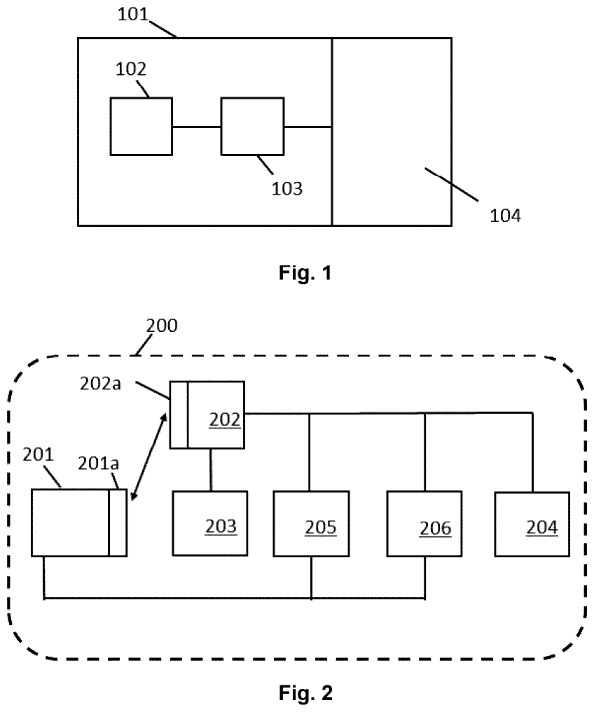

FIG. 1 is a functional block diagram of a non-limiting example of a device 101 implementing one of the methods described according to one or more embodiments.

The device comprises a non-volatile memory 102, a processor 103 and a communication interface 104, the elements being connected by an internal communication bus. The memory 102 comprises software code. The device is configured to implement one of the described methods when the processor executes the software code.

The device 101 may comprise different or additional components. In one use case, the device 101 is an electricity meter and will therefore include components of this type of equipment: a circuit breaker, a metering processor, electrical terminals, a human-machine interface, etc. In other use cases, the device 101 is a computer or a server. The device 101 is, for example, a server of an energy or fluid distribution network operator, or a cloud server.

Depending on the implementation, the device 101 can receive all or some of the data required to implement one of the described methods. It can generate some of this data itself, for example when the device 101 is an electricity meter.

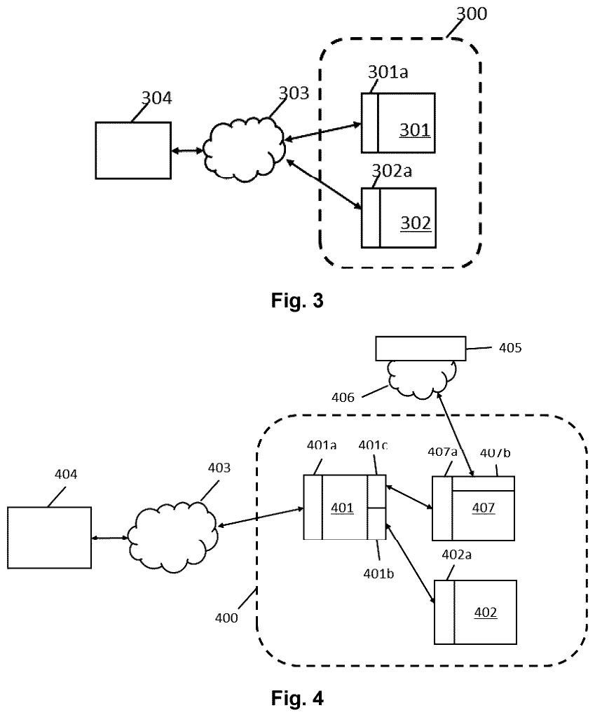

FIG. 2, FIG. 3 and FIG. 4 are schematic block diagrams of three system architectures including a device 101 according to the present disclosure. The architectures differ with regard to the device that implements one of the methods described and to how the method input data reach this device. These are just a few examples of real-life situations. However, other architectures are also possible.

In the example shown in FIG. 2, the method is implemented locally by an electricity meter.

FIG. 2 shows a premises 200, for example the home of a power grid subscriber. The system includes an electricity meter 201, comprising a communication interface 201a. The meter 201 implements one of the methods described—for example, the device 101 of FIG. 1. The premises also includes at least one fluid meter 202, the fluid meter comprising a communication interface 202a. The fluid meter is, for example, a water meter or a gas meter, noting that several meters of different resources may be present depending on each implementation. For the sake of clarity of the examples, a single fluid meter, i.e. a water meter, will be considered. The devices 201 and 202 measure the overall consumption of electricity and water, respectively, of appliances in the premises.

The premises 200 includes one or more domestic appliances. For example, the premises 200 includes one or more water-consuming electrical appliances (devices 205 and 206) and one or more water-consuming non-electrical devices (devices 203 and 204).

The devices 201 and 202 exchange data via their respective communication interfaces. These communication interfaces are, for example, wireless interfaces such as “WM-Bus”. The electricity meter 201 can thus receive the load curve from the water meter 202. The data exchanges can optionally be encrypted.

The electricity meter 201 is configured to implement one of the methods described. The subscriber user can then obtain the disaggregation results directly from the electricity meter (for example, by displaying them on a screen of the meter, loading them onto a cell phone or computer, etc.).

FIG. 3 is an example of a different architecture, wherein a server receives the electricity and fluid-consumption data and carries out the processing according to one of the methods described. The server is, for example, a remote server communicating with the meters via a suitable communication network. This is advantageous in that an existing interface of meters connected to an external communication network is used to transmit the method input data. This architecture is particularly interesting in terms of infrastructure.

A subscriber household 300 comprises an electricity meter 301 provided with a communication interface 301a, and a fluid meter 302 provided with a communication interface 302a. The two meters communicate with a server 304, which is, for example, a server of the electricity distribution network operator. The communication network 303 used is, for example, a cellular network. The various appliances consuming electricity and/or fluid present in the premises are not illustrated for the sake of clarity of the figure.

According to the example of FIG. 3, the electricity meter 301 disaggregates the electrical data and supplies the load curves for each electrical device directly to the server 304. The water meter transmits the overall water load curve to the server 304. The server 304, which may be the device of FIG. 1, implements one of the methods described. The various domestic appliances are not illustrated for the sake of clarity of the figure.

The subscriber user can then obtain the disaggregation results from the server 304, for example via an application on their cell phone or computer.

FIG. 4 is a third example of an architecture, wherein one of the methods described is implemented by a server 405 in the cloud 406, with the method input data being transmitted by the electricity meter 401 of a subscriber premises 400 to the server 405 via an internet gateway (or box) 407. The water-consumption load curve is transmitted by a water meter 402 to the electricity meter 401 locally, before transmission by the latter to the cloud server 405. The cloud server 405 can transmit the output results of the method back to the electricity meter 401, for access by the user. FIG. 4 also illustrates a server 404 of the electricity network operator and a network 403 used for communication with the electricity meter 401.

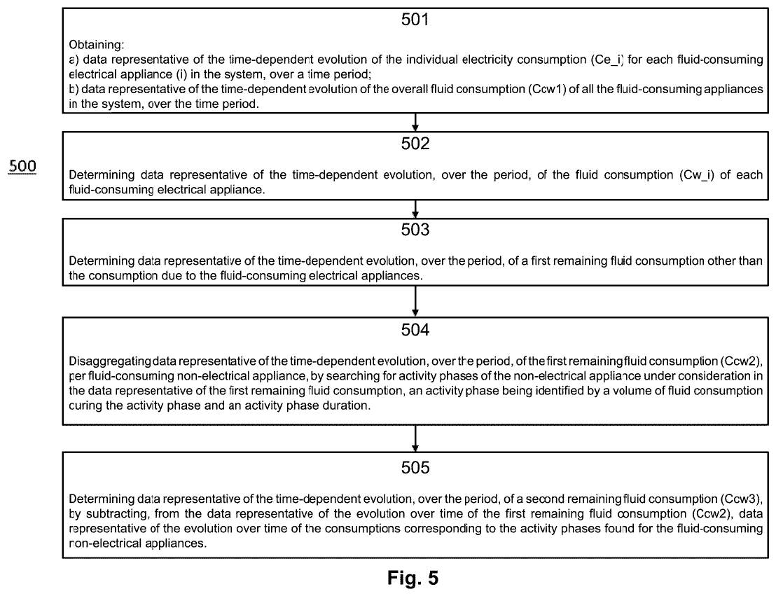

As with the previous architectures, the devices of FIG. 4 include communication interfaces for the above-mentioned exchanges. A reference of type x.y designates an interface y of a device x. For example, and without limitation, the interfaces 401b and 402a can be WM-Bus interfaces, the interfaces 401c and 407a can be IEEE 802.11 (“Wi-Fi”) interfaces, the interface 407b can be a fiber, cable or ADSL interface, the interface 401a can be a cellular network interface. According to one non-limiting embodiment illustrated in FIG. 5, a method 500 for disaggregating fluid-consumption data comprises:
501: Obtaining
a) data representative of the time-dependent evolution of the individual electricity consumption (Ce_i) for each fluid-consuming electrical appliance (i) in the system, over a time period;
b) data representative of the time-dependent evolution of the overall fluid consumption (Ccw1) of all the fluid-consuming appliances in the system, over the time period.

It should be noted that data representative of the time-dependent evolution of the individual electricity consumption (Ce_i) for each fluid-consuming electrical appliance (i) in the system, over a time period, can be obtained directly by the device 101 from a third-party device that has performed a disaggregation of an overall electricity load curve, or this disaggregation is performed by the device 101 itself.
502: Determining data representative of the time-dependent evolution, over the period, of the fluid consumption (Cw_i) of each fluid-consuming electrical appliance.
503: Determining data representative of the time-dependent evolution, over the period, of the remaining fluid consumption other than the consumption due to the fluid-consuming electrical appliances (Ccw2). This can be done by simply subtracting, from the overall fluid-consumption data (Ccw1), fluid-consumption data (Cw_i) of each fluid-consuming electrical appliance

$$( Ccw 2 = Ccw 1 - {\sum }_{i = 1}^{i = N} Cw\_i ) .$$

The subtraction is performed, for example, on a sample-by-sample basis, between samples corresponding to the same point in time.
504: Disaggregating the time-dependent evolution of the first remaining fluid consumption (Ccw2) over the period, per type of fluid-consuming non-electrical appliance, by searching for activity phases of the type of non-electrical appliance considered in the data representative of the time-dependent evolution of the first remaining fluid consumption, an activity phase being identified by a volume of fluid consumption during the activity phase and a duration of the activity phase.

The individual fluid load curve (Cw_i) for each fluid-consuming electrical appliance (i) is determined by identifying the activity phases of this appliance in the individual electricity load curve of this equipment. For each activity phase of an appliance, a fluid load curve covering the activity phase is available. A fluid load curve covering an activity phase is obtained, for example, either by prior learning or by continuous analysis of the method input data. These two options are described in greater detail hereinafter. The individual fluid load curve of the appliance is obtained by aggregating the fluid load curves corresponding to the different activity phases identified. For example, if a washing machine is used at 10 a.m. with program 1 and at 4 p.m. with program 2, its individual fluid load curve over a day will be obtained by inserting the fluid load curve corresponding to program 1 at 10 a.m. and the one corresponding to program 2 at 4 p.m., consumption being zero during the day outside these two activity phases.

Optionally, it is also possible to determine, in a step 505, the load curve (“Ccw3”), corresponding to the various fluid consumptions due to appliances or equipment that have not resulted in disaggregation, by subtracting from Ccw2 all the fluid consumptions determined in step 504. This step can be described as follows: Determining data representative of the time-dependent evolution, over the period, of a second remaining fluid consumption (Ccw3), by subtracting, from the data representative of the evolution over time of the first remaining fluid consumption (Ccw2), data representative of the evolution over time of the consumptions corresponding to the activity phases found for the fluid-consuming non-electrical appliances.

Appliances or equipment that have not been disaggregated include for example appliances or equipment for which data on average fluid consumption and consumption phase duration are not available or are meaningless, such as for example the consumption of a kitchen faucet.

The data representative of the time-dependent evolution of the consumption of electricity or fluid are also referred to as “load curves” (electricity load curve or fluid load curve). An “overall” load curve covers the consumption of all the appliances served by a single source, connected to a meter that makes it possible to measure the consumption of the resource supplied by this source. An “individual” load curve covers the consumption of a single appliance. Typically, both the overall and individual load curves will be considered over the same time period. Load curves corresponding only to an activity phase of a piece of equipment will also be addressed.

By way of example, a load curve can, for example, be represented by consecutive consumption data. By way of non-limiting but realistic example in the context of a household, the data may have a sampling frequency of, for example, one minute, over a total period of one day. Other sampling frequencies and period lengths can, of course, be chosen according to the use case and/or the accuracy required, etc. The values given are only given by way of examples of real use cases. The present disclosure refers indistinctly to load curves for a time period, and to data representative of the time-dependent evolution of the consumption of electricity, fluid, etc. for the time period. In some of the steps described, load curves must be subtracted. For example, fluid load curves corresponding to activity phases of electrical equipment must be subtracted from an overall fluid load curve. A skilled person will know how to adjust the sampling frequencies, as needed, if they must be different, and how to match the samples of the different load curves in time, so that the subtraction can be carried out correctly.

The disaggregation method uses the individual load curves of electricity consumption (Ce_i) of the fluid-consuming electrical appliances. Obtaining these individual load curves of electricity consumption is, as such, outside the scope of the present disclosure. According to one particular example, these individual load curves of electricity consumption are obtained by disaggregating the overall load curve of electricity consumption (Ce). This disaggregation is typically carried out by the electricity meter, with the disaggregated data supplied to the device 101 if the latter is not the electricity meter. In the first case, the overall load curve of electricity consumption is one of the input data of the method of FIG. 5. In practice, disaggregation is-generally, but not necessarily-carried out by an electricity meter, which has direct access to the overall electricity load curve, since the production of data representing the load curve is a natural part of its functions. The electricity meter can then either use the actual disaggregated data or, if the method is implemented by another device, transmit these data to the other device.

Methods for disaggregating an overall electricity load curve are also known elsewhere. An example is given in (i), which describes a generative model for simulating high-frequency data of electric current, using unsupervised learning techniques based on a method belonging to the Independent-Variation Matrix Factorization (IVMF) family, which makes it possible to express a current observation matrix as the product of two matrices: signatures and activations.

According to one embodiment, learning or non-learning phases can be provided to determine at least one of:
data representative of the time-dependent evolution of the fluid consumption (Cw_i) per fluid-consuming electrical appliance, for an activity phase, and
data representative of the average fluid consumption and consumption phase duration, per fluid-consuming non-electrical appliance, for an activity phase.

These are the individual fluid load curves of the electrical or non-electrical appliances for individual activity phases, which are then used to compose the complete individual load curves over the entire time period under consideration. These learning phases are carried out prior to the implementation of the method according to FIG. 5.

According to one particular alternative, the first learning phase hereinbefore is carried out and empirical data are used instead of the second phase.

The data representative of the individual load curves of electricity consumption make it possible to accurately know the start time (Td) and the end time (Tf) of the period of activity of a piece of electrical equipment that additionally consumes fluid, and therefore the activity phases of this piece of equipment. It should be noted that fluid consumption does not necessarily occur throughout the entire period of activity of a fluid-consuming electrical appliance. A washing machine may well have a filling phase, and then consume no more water until a rinsing phase.

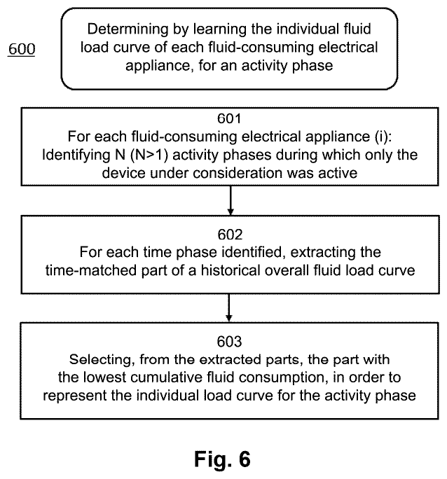

FIG. 6 is a flowchart illustrating a non-limiting example of a learning phase 600 to determine the fluid load curve (Cw_i) of a piece of electrical equipment during an activity phase of said piece of equipment. Knowing this fluid load curve for an activity phase then makes it possible to determine the share of fluid consumed by the piece of equipment, during its various activity phases, in the overall fluid load curve of the household.

The method of FIG. 6 comprises:
identifying (601) N activity phases during which only the device under consideration was active, with N>1;
for each activity phase identified, extracting (602) a time-matched part of data representative of the evolution over time of the historical overall fluid consumption;
selecting (603), from the extracted parts, the part with the lowest cumulative fluid consumption as data representative of the time-dependent evolution of the fluid consumption (Cw_i) per fluid-consuming electrical appliance.

The learning is carried out for each fluid-consuming electrical device. It is carried out using data covering a historical period and comprising:
the individual load curves of electricity consumption (Ce_i) of the fluid-consuming electrical devices for the historical period, and
the overall fluid-consumption load curve for the historical period.

The learning phase can be performed, for example, over a historical period of the order of one week, or much longer according to the devices present, with the aim of having enough phases wherein every piece of equipment has its own active phases without other devices being active at the same time.

According to a particularly advantageous example of the learning phase, for each fluid-consuming electrical device, N (N>1) time-based activity phases are identified, during which only the device under consideration is active. This identification is carried out using individual electricity load curves. The overall water-consumption load curve Cw is considered for these N phases. Although only the device under consideration is active, other non-electrical equipment may be consuming fluid during the identified phases. To limit the risk of an incorrect estimate, the phase is selected among the N selected phases for which the total water consumption over the phase is the lowest. The use of N phases reduces the potential impact of various pieces of water-consuming equipment. By way of example, the value of N=3 can be taken.

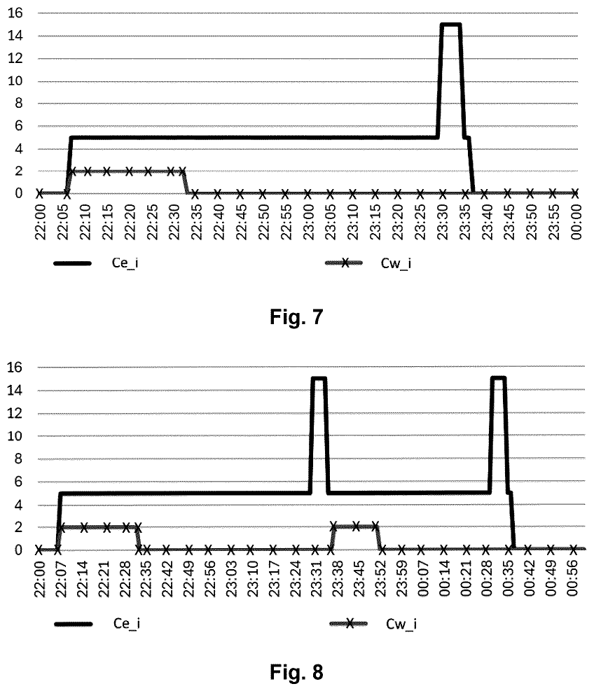

The learning phase can be carried out independently for several discrete operating modes or programs. For example, a washing machine generally has several wash modes, each lasting a different amount of time and consuming different amounts of water. The modes of a device can be disambiguated based on their duration. FIG. 7 and FIG. 8 are graphs showing two electricity and water load curves for two different washing machine programs, thus corresponding to two different activity phases. For the sake of simplicity, an “activity phase” is considered to correspond to the period during which electricity consumption is not zero. FIG. 7 shows the electricity consumption Ce_i (in Wh) and the water consumption Cw_i of the washing machine of a household during a 90-minute program including a spin cycle. It is noted that Td=10:07 p.m. and Tf=11:37 p.m. FIG. 8 shows the electricity consumption Ce_i as well as the water consumption Cw_i of the washing machine of a household during a 150-minute program including two spin cycles. It is noted that Td=10:07 p.m. and Tf=12:37 a.m.

At the end of the learning phase, for each fluid-consuming electrical device, there is one fluid load curve during an activity phase, and, if needed, several load curves corresponding to several different operating modes, respectively.

Optionally, the learning is repeated from time to time, for example periodically (for example every month). This makes it possible to adapt to consumption changes in a household.

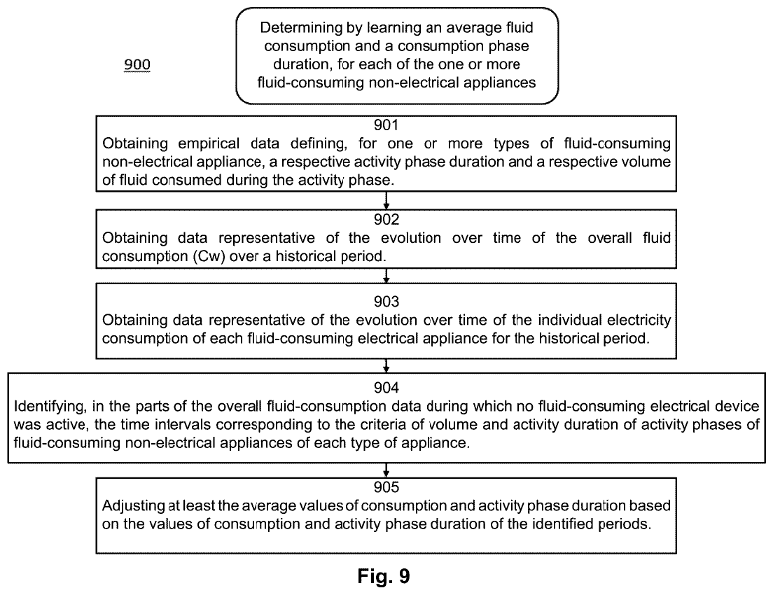

A non-limiting example of learning-based determination of data representative of the average fluid consumption and consumption phase duration, per fluid-consuming non-electrical appliance, will now be described. This example is illustrated by the flowchart of FIG. 9. The illustrated method 900 comprises:
obtaining (901) empirical data defining, for one or more types of fluid-consuming non-electrical appliance, a respective activity phase duration and a respective volume of fluid consumed during the activity phase;
obtaining (902) data representative of the evolution over time of the overall fluid consumption (Cw) over a historical period;
obtaining (903) data representative of the evolution over time of the individual electricity consumption of each fluid-consuming electrical appliance for the historical period;
identifying (904), in the parts of the overall fluid-consumption data during which no fluid-consuming electrical device was active, the time intervals corresponding to the criteria of volume and activity duration of activity phases of fluid-consuming non-electrical appliances of each type of appliance;
adjusting (905) at least the values of consumption volume and activity phase duration on the basis of the values of consumption and activity phase duration of the identified intervals.

In a more detailed manner, the device 101 has access to empirical data known elsewhere, which describe, for one or more types of water-consuming non-electrical appliance, usually found in a household, an activity phase duration and a volume of fluid consumed during the activity phase. Preferably, every possible type of appliance is considered. These values can be defined by ranges or by a central value and a margin around this central value. They will be used to identify, in the overall fluid load curve, periods corresponding to activity phases of a particular type of fluid-consuming non-electrical appliance.

Examples of empirical data are as follows:
Flush mechanism: water consumption: 6 L±3 L/Duration: 0 min 30 s to 1 min 30 s
Shower: Water consumption: 30 L to 80 L/Duration: 2 min 00 s to 8 min 00 s
Bath: Water consumption: 110 L to 220 L/Duration: 10 min 00 s to 20 min 00 s

As in the previous case, the learning phase takes place over a time interval of historical data. The periods of this interval during which no water-consuming electrical equipment is consuming electricity are taken into account over this interval. The periods corresponding to the criteria of volume and activity duration of fluid-consuming non-electrical appliances are identified as potentially corresponding to the consumption of one of these appliances, and are associated with the corresponding appliance type. At least the average values of consumption and activity phase duration are then adjusted based on the values of consumption and activity phase duration of the identified periods.

According to one exemplary embodiment, all the eligible periods are stored, and the number of eligible periods for each type of equipment is counted. The phase of identifying eligible periods continues until a stopping criterion is met. This stopping criterion is, for example, linked to the minimum number of periods collected for each type of equipment. For example, this minimum number is M, with M>1.

With respect to the example hereinbefore, the number of eligible periods is C for non-electric flushing mechanisms, D for showers and B for baths. The learning phase lasts at least one week and only ends when min (B, C, D)≥3.

For each type of appliance potentially detected, an average fluid consumption value and an average activity phase duration are determined based on the periods associated with the appliance type.

With respect to the previous example (non-electric flush mechanism, shower, bath), the average water consumption and the average duration of the C phases stored (non-electric flush mechanism), D phases stored (shower) and B phases stored (bath) are taken as the average values.

Empirical data were thus used to identify corresponding behaviors in the overall fluid load curve, and to adjust both the average consumption and the activity phase duration for each type of appliance, based on actual measurements taken in the premises. The margins around this mean value are, at least in this example, taken from the empirical data, but they can also be adjusted based on the historical data. For example, the learning margins can be deduced by determining a standard deviation σ and taking a margin of ±3σ. Functions other than standard deviation and coefficients other than coefficient “3” can be considered, and these examples are for illustrative purposes only.

Using the previous example, the adjusted values are, for example, as follows:
Non-electric flush mechanism: 6.1 L±3 L/45 s±30 s
Shower: 48 L±10 L/4 minutes±3 minutes
Bath: 151 L±55 L/14 minutes±5 minutes

According to one alternative embodiment, if no potential period of use is identified for an appliance type, for example after one week, the empirical data are used to determine an average fluid consumption and an average activity phase duration, and the condition for ending the learning phase then ignores said appliance type.

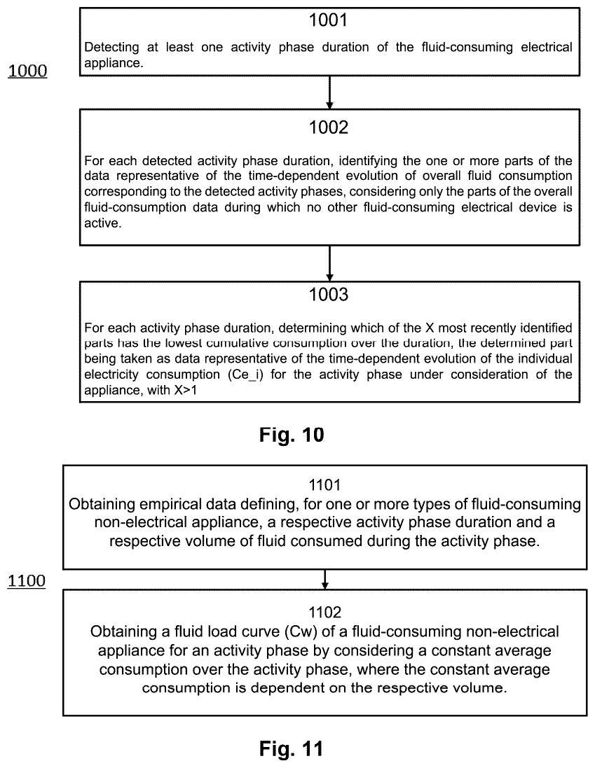

To return to the previous example, for baths, a water consumption range of 110 L to 220 L is considered, with an average value of 165 L, and a duration range of 10 min 00 s to 20 min 00 s, with an average value of 15 min 00 s. FIG. 10 is a flowchart of a method 1000 for determining the individual fluid load curve (Ce_i) for an activity phase of a fluid-consuming electrical appliance (i), which does not require any prior learning, the determination being carried out on the fly with the method input data.

The method of FIG. 10 comprises, for each electrical appliance which is also a fluid consumer:
detecting (1001) one or more activity phase durations of the fluid-consuming electrical appliance;
for each detected activity phase duration, identifying (1002) the one or more parts of the data representative of the time-dependent evolution of the overall fluid consumption corresponding to the detected activity phases, considering only the parts of the overall fluid-consumption data during which no other fluid-consuming electrical device is active;
for each activity phase duration, determining (1003) which of the X most recently identified parts has the lowest cumulative consumption over the duration, the determined part being taken as data representative of the time-dependent evolution of the individual electricity consumption (Ce_i) for the activity phase under consideration of the appliance, with X>1.

As described elsewhere, the individual fluid load curve (Ce_i) for the fluid-consuming electrical appliance can be obtained by combining the one or more activity phase fluid load curves according to the activity phases detected in the individual electricity load curve of the appliance.

X can be taken, for example, to equal three. Considering several parts of equal duration of the overall fluid load curve reduces the impact of non-water-consuming electrical equipment.

According to one embodiment, the fluid load curve per activity phase of an appliance is continuously updated.

FIG. 11 is a flowchart of a method for determining data representative of the average fluid consumption and consumption phase duration, per fluid-consuming non-electrical appliance, without prior learning. In this case, the empirical data on fluid consumption and activity phase duration are used, without adjustment on the basis of actual consumption data received for the household under consideration. If the consumption data are provided in the form of a range (for example, “110 liters to 220 liters”), the device 101 will determine an average value (“165 liters”). The load curve for the activity phase will be the constant average value of continuous consumption over the duration of the phase.

### LIST OF CITED DOCUMENTS

(i) Simon HENRIET “La désagrégation de consommations électriques dans les grands bâtiments: analyses, simulations et apprentissage non-supervisé par factorisation de matrices” Signal and Image Processing. Institut Polytechnique de Paris, 2020. NNT: 2020IPPAT007

1. A method implemented by a device comprising a processor for determining fluid consumption by a non-electrical appliance in a system comprising at least one fluid-consuming electrical appliance, and at least one fluid-consuming non-electrical appliance, the method comprising:
obtaining:
a) data representative of the time-dependent evolution of the individual electricity consumption for each fluid-consuming electrical appliance in the system, over a time period;
b) data representative of the time-dependent evolution of the overall fluid consumption of all the fluid-consuming appliances in the system, over the time period;
determining data representative of the time-dependent evolution, over the period, of the fluid consumption of each fluid-consuming electrical appliance by identifying activity phases of this electrical appliance in the data representative of the time-dependent evolution of the individual electricity consumption of this electrical appliance;
determining data representative of the time-dependent evolution, over the period, of a first remaining fluid consumption other than the consumption due to fluid-consuming electrical appliances;
disaggregating the data representative of the time-dependent evolution, over the period, of the first remaining fluid consumption, per fluid-consuming non-electrical appliance, by searching for activity phases of the non-electrical appliance under consideration in the data representative of the first remaining fluid consumption, and
an activity phase being identified by a volume of fluid consumption during the activity phase and a duration of the activity phase.

2. The method according to claim 1, comprising aggregating fluid load curves corresponding to the different activity phases identified in the data representative of the time-dependent evolution of the individual electricity consumption of the electrical appliance, the device having, for each activity phase of this electrical appliance, a fluid load curve covering this activity phase.

3. The method according to claim 1, comprising determining data representative of the time-dependent evolution, over the period, of a second remaining fluid consumption, by subtracting, from the data representative of the evolution over time of the first remaining fluid consumption, data representative of the evolution over time of the consumptions corresponding to the activity phases found for the fluid-consuming non-electrical appliances.

4. The method according to claim 1, wherein a fluid-consuming non-electrical appliance comprises a plurality of operating modes, each operating mode being associated with an activity phase identified by a specific consumption volume and consumption phase duration.

5. The method according to claim 1, wherein the search for an activity phase comprises identifying a constant consumption corresponding to the consumption volume of this activity phase, over the duration of the activity phase.

6. The method according to claim 1, which comprises a preliminary learning phase for obtaining data representative of the time-dependent evolution of the fluid consumption per fluid-consuming electrical appliance, for an activity phase of the fluid-consuming electrical appliance under consideration, the learning phase comprising, for each fluid-consuming electrical appliance:
identifying N activity phases during which only the device under consideration was active, with N>1;
for each activity phase identified, extracting a time-matched part of data representative of the evolution over time of the historical overall fluid consumption; and
selecting, from the extracted parts, the part with the lowest cumulative fluid consumption as data representative of the time-dependent evolution of the fluid consumption per fluid-consuming electrical appliance.

7. The method according to claim 1, comprising a preliminary learning phase for determining a volume and duration for an activity phase of a fluid-consuming non-electrical appliance, the learning phase comprising:
obtaining empirical data defining, for one or more types of fluid-consuming non-electrical appliance, a respective activity phase duration and a respective volume of fluid consumed during the activity phase;
obtaining data representative of the evolution over time of the overall fluid consumption over a historical period;
obtaining data representative of the evolution over time of the individual electricity consumption of each fluid-consuming electrical appliance for the historical period;
identifying, in the parts of the overall fluid-consumption data during which no fluid-consuming electrical device was active, the time intervals corresponding to the criteria of volume and activity duration of activity phases of fluid-consuming non-electrical appliances of each type of appliance; and
adjusting at least the values of consumption volume and activity phase duration on the basis of the values of consumption and activity phase duration of the identified intervals.

8. The method according to claim 1, wherein obtaining data representative of the time-dependent evolution of the individual electricity consumption for each fluid-consuming electrical appliance (i) of the system, over a time period, comprises:
detecting one or more activity phase durations of the fluid-consuming electrical appliance;
for each detected activity phase duration, identifying the one or more parts of the data representative of the time-dependent evolution of the overall fluid consumption corresponding to the detected activity phases, considering only the parts of the overall fluid-consumption data during which no other fluid-consuming electrical device is active; and
for each activity phase duration, determining which of the X most recently identified parts has the lowest cumulative consumption over the duration, the determined part being taken as data representative of the time-dependent evolution of the individual electricity consumption for the activity phase under consideration of the appliance, with X>1.

9. The method according to claim 1, wherein the system is a household.

10. The method according to claim 1, comprising one of the following:
transmitting data representative of the time-dependent evolution, over the period, of the first remaining fluid consumption, per fluid-consuming non-electrical appliance; or
displaying data representative of the time-dependent evolution, over the period, of the first remaining fluid consumption, per fluid-consuming non-electrical appliance.

11. A device provided with a processor and a memory including software instructions, the device being caused to perform the method of claim 1 when the processor executes the instructions.

12. The device according to the claim 11, wherein the device is one among: an electricity meter, a server.
